(19) United States
(12) Patent Application Publication
(10) Pub. No.: US 2015/0362589 A1
(43) Pub. Date: Dec. 17, 2015

(54) ANTI-SCRATCHING PROTECTION FOR ACOUSTIC SENSORS

(71) Applicant: INVENSENSE, INC., San Jose, CA (US)

(72) Inventor: Julius Ming-Lin Tsai, San Jose, CA (US)

(73) Assignee: INVENSENSE, INC., San Jose, CA (US)

(21) Appl. No.: 14/302,897

(22) Filed: Jun. 12, 2014

(51) Int. Cl. G01S 7/521; B05D 1/36; B05D 5/00; G01S 15/89

(52) U.S. Cl. CPC G01S 7/521; G01S 15/8925; B05D 1/36; B05D 5/00

(57) ABSTRACT

An acoustic sensing element of an acoustic sensor and/or transducer can be covered with a composite material comprising a cover material and an anti-scratch material. In one aspect, an acoustic impedance of the cover material is lower than an acoustic impedance of the anti-scratch material. During acoustical sensing, the acoustic sensing element transmits an ultrasonic signal through the cover material and the anti-scratch material, which interferes with an object on (or near) the surface of the anti-scratch material. An interference signal that is generated based on an interference of the ultrasonic signal with the object propagates through the anti-scratch material and the cover material and is sensed by the acoustic sensing element. Further, an image of the object is recreated based on an analysis of the interference signal.

### TECHNICAL FIELD

The subject disclosure relates to acoustic sensors, e.g., to anti-scratching protection for acoustic sensors.

### BACKGROUND

Fingerprint sensors are one of the most widely accepted and utilized biometric authentication and identification sensors. Typically, fingerprint sensors capture a digital image of a fingerprint pattern, which can be digitally processed to facilitate authentication and/or identification of an entity. Fingerprint sensors can be categorized into three major groups based on the detection methods utilized to capture the digital image, namely, optical fingerprint sensors, capacitive fingerprint sensors, and acoustic fingerprint sensors.

Optical fingerprint sensors are extensively used, for example, by government entities and/or law enforcements. Optical fingerprint sensors utilize a light source to project light onto a piece of transparent slab (e.g., glass) such that the light is internally reflected due to reflection index difference with air above the slab. When a finger is in contact with the surface of the slab, the total internal reflection condition is disturbed and creates shadows at a detector. Based on an analysis of the shadows an image of the fingerprint can be recreated. This sensing method is reliable and accurate but the sensing devices are normally bulky and the image quality is easily contaminated due to surface conditions. In addition, due to the high acquisition accuracy requirements for sensing, the sensing time can be significantly long.

Capacitive fingerprint sensors are smaller in size and can easily be integrated within mobile devices such as laptops and cell phones. Capacitive fingerprint sensors utilize miniature electrodes arrays to detect either a capacitance or impedance difference between valleys and ridges of a fingerprint. However, the power consumption of capacitive fingerprint sensors is significantly high. In addition, accuracy of the sensors is easily affected by surface conditions. To prevent scratches on the surface that would reduce accuracy, a single layer of anti-scratch material is placed over the sensor. For example, a piece of sapphire is employed as anti-scratch protection. This anti-scratch solution works for capacitive sensors that utilize electrical impedance but will fail for acoustic impedance sensing due to the high acoustical impedance value of the anti-scratch material layer.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

The systems and methods described herein, in one or more embodiments thereof, relate to an acoustic sensor that comprises an acoustic sensing element and a cover material deposited between the acoustic sensing element and an anti-scratch material. In one aspect, an acoustic impedance of the cover material is lower than an acoustic impedance of the anti-scratch material.

An aspect of the disclosed subject matter relates to a method that comprises forming a first layer of a cover material on an acoustic sensing element and forming a second layer of an anti-scratch material on the cover material, wherein an acoustic impedance of the cover material is lower than an acoustic impedance of the anti-scratch material. Further, yet another aspect of the disclosed subject matter relates to an acoustic sensing method that comprises transmitting, by an acoustic sensing element, an ultrasonic signal through a cover material and an anti-scratch material. Moreover, the cover material is deposited between the acoustic sensing element and the anti-scratch material and an acoustic impedance of the cover material is lower than an acoustic impedance of the anti-scratch material. Furthermore, the acoustic sensing method comprises sensing, by the acoustic sensing element, an interference signal that is generated based on an interference of the ultrasonic signal with an object and that propagates through the anti-scratch material and the cover material. As an example, the interference signal can be analyzed to recreate an image of the object.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

The numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates an example system that can be utilized for sensing an acoustic signal;

FIG. 2 illustrates an example system depicting another implementation of an acoustic sensor that includes a composite material deposited over an acoustic sensing element;

FIG. 3 illustrates an example system depicting yet another implementation of an acoustic sensor that includes a composite material deposited over an acoustic sensing element;

FIG. 4 illustrates example simulation results for transmission efficiency of an acoustic sensor that utilizes a composite material deposited over an acoustic sensing element;

FIG. 5 illustrates an example system utilized for analysis of acoustically sensed data;

FIG. 6 illustrates an example methodology for forming an acoustic sensor that includes a composite material deposited over an acoustic sensing element; and

FIG. 7 illustrates an example methodology for determining an image of an object based on acoustic sensing.

### DETAILED DESCRIPTION OF THE INVENTION

One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details, e.g., without applying to any particular networked environment or standard. In other instances, well-known structures and devices are shown in block diagram form in order to facilitate describing the embodiments in additional detail.

Systems and methods disclosed herein, in one or more aspects provide anti-scratching protection for acoustic sensors/transducers. The subject matter is described with reference to the drawings, wherein like reference numerals are used to refer to like elements throughout. In the following description, for purposes of explanation, numerous specific details are set forth in order to provide a thorough understanding of the subject innovation. However, that the subject matter may be practiced without these specific details.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling. In addition, the words “example” and/or “exemplary” are used herein to mean serving as an example, instance, or illustration. Any aspect or design described herein as “example” and/or “exemplary” is not necessarily to be construed as preferred or advantageous over other aspects or designs. Rather, use of the word exemplary is intended to present concepts in a concrete fashion.

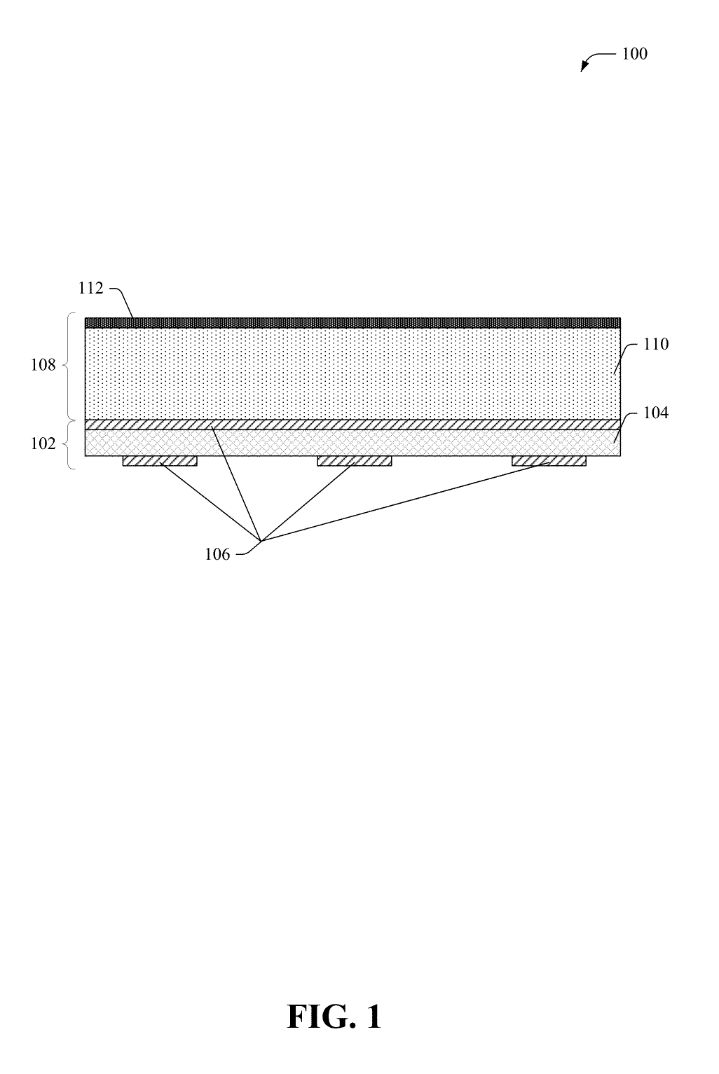

Initially, referring to FIG. 1, there illustrated is an example system 100 that can be utilized for sensing an acoustic signal. The system 100 can include most any electrical device that converts an audio signal (e.g., sound waves) into mechanical vibrations and/or electrical signals. In one aspect, the system 100 can be an acoustic sensor (e.g., a piezoelectric sensor and/or transducer) that comprises an acoustic sensing element 102 for generating and/or sensing acoustic waves. The acoustic sensing element 102 can be a smallest sensing unit which can respond to an acoustic wave in an environment surrounding the unit and transform the acoustic energy of the wave into electrical energy. An object in a path of the generated acoustic wave(s) can create an interference (e.g., in time of flight, amplitude, frequency and/or phase) that can then be sensed by the acoustic sensing element 102. The interference can be analyzed to determine an image and/or physical parameters such as (but not limited to) distance, density and/or speed of the object. As an example, the system 100 can be utilized in various applications, such as, but not limited to, wireless devices, industrial systems, automotive systems, robotics, telecommunications, security, medical devices, etc. In one aspect, system 100 can be part of a sensor array (e.g., two-dimensional array, one-dimensional array, etc.) comprising a plurality of acoustic sensors deposited on a wafer.

In an aspect, the acoustic sensing element 102 can comprise a piezoelectric material 104, such as, but not limited to, Aluminum nitride (AlN), Lead zirconium titanate (PZT), etc. to facilitate acoustic sensing. Specifically, the piezoelectric material 104 can generate electric charges under mechanical stress and conversely experience a mechanical strain in the presence of an electric field. More specifically, the piezoelectric material 104 can sense mechanical vibrations caused by an acoustic signal and produce an electrical charge at the frequency of the vibrations. Additionally, the piezoelectric material 104 can generate an acoustic wave by vibrating in an oscillatory fashion due to an input current generated by an alternating current (AC) voltage applied across the piezoelectric material 104. As an example, the frequency of vibration can be same and/or different from the frequency of the AC voltage and/or current. It is noted that the piezoelectric material 104 can include most any material (or combination of materials) that exhibits piezoelectric properties, such that the structure of the material under a tensile or compressive stress applied to the material alters the separation between positive and negative charge sights in a cell causing a polarization at the surface of the material. The polarization is directly proportional to the applied stress and is direction dependent so that compressive and tensile stresses results in electric fields of opposite voltages. Further, the acoustic sensing element 102 can comprise a set of patterned electrodes 106 that supply and/or collect the electrical charge to/from the piezoelectric material 104. As an example, the electrodes 106 can be most any metal layers, such as, but not limited to, Aluminum (Al)/Titanium (Ti), Molybdenum (Mo), etc., that are patterned to form shapes (e.g., circle, square, octagon, hexagon, etc.), which are defined in-plane with the piezoelectric material 104.

One of the advantages of using an acoustic sensor of system 100 (versus capacitive or optical sensors) is the in-depth and detailed information that can be determined based on the sensing. For example, during an ultrasonic scan for fingerprinting, the acoustic wave can penetrate deep into different layers (e.g., skin, tissue, bone etc.) of the finger, such that different layers, such as, but not limited to epi-dermis, dermis layer, blood vessels or bones can be differentiated and data associated with the different layers can be sensed/collected. This provides additional security with bio-authentication. Conventional capacitive sensors utilize miniature electrodes arrays to detect either the capacitance or electrical impedance difference generated by an object on the surface of the sensor. However, capacitive sensors can only differentiate between the ridges and valleys on the fingerprint on the surface of the finger.

Typically, capacitive sensors are made only of complementary metal-oxide-semiconductor (CMOS) chips or of a combination of a laminate capacitive electrodes array in conjunction with CMOS chips for cost reduction. Further, the capacitive sensors utilize a thick piece of sapphire placed on (over the surface of) and in contact with a capacitive sensing element. In addition to protecting the capacitive sensing element from scratches, the piece of sapphire improves the signal to noise ratio due to of the high dielectric constant. However, sapphire (or most any material with Mohs hardness greater than 7) has a substantially high acoustic impedance that provides impedance mismatch during acoustic sensing. For example, during fingerprint scanning, the large difference between the acoustic impedance of sapphire and that of human skin can cause an impedance mismatch.

Referring back to FIG. 1, system 100 utilizes a composite material 108 that is a combination of an impedance-matched cover material 110 and anti-scratch material 112 over the acoustic sensing element 102 to provide scratch resistance. Moreover, the composite material 108 allows the acoustic wave to propagate to/from the acoustic sensing element 102 with minimum attenuation and prevents scratches that can damage the acoustic sensing element 102 and/or generate errors during sensing. In one aspect, the low acoustic impedance cover material 110 is placed such that one side of the cover material 110 is in contact with the acoustic sensing element 102 and the other side of the cover material 110 is in contact with a thin layer of the high acoustic impedance anti-scratch material 112. The remaining side of anti-scratch material 112 can serve as a contact surface of the acoustic sensor, for example, a surface on which an object (e.g., human finger) to be sensed is placed.

According to an embodiment, the acoustic impedance of the cover material 110 is lower than the acoustic impedance of the anti-scratch material 112, such that the acoustic wave is efficiently propagated to/from the acoustic sensing element 102. As an example, the cover material 110 can comprise various materials having an acoustic impedance in the range between 0.8 to 4 MRayl, such as, but not limited to, plastic, resin, rubber, Teflon, etc. Typically, the cover material 110 can be selected based on an application of the sensor. For instance, in fingerprinting applications, a cover material 110 having an acoustic impedance that matches (e.g., exactly or approximately) the acoustic impedance of human skin (e.g., 1.6×10⁶Rayl) can be selected. Further, in one aspect, the thickness of anti-scratch material 112 can be less than the wavelength of the acoustic wave that is to be generated and/or sensed by the acoustic sensing element 102 (e.g., to provide minimum interference during propagation of the acoustic wave). As an example, the anti-scratch material 112 can comprise various hard and scratch-resistant materials (e.g., having a Mohs hardness of over 7 on the Mohs scale), such as, but not limited to sapphire, glass, MN, Titanium nitride (TiN), Silicon carbide (SiC), diamond, etc. Since the acoustic wave attenuation in the cover material is negligible, the cover material 110 can have most any thickness, for example, based on a desired size/cost of the sensors for a specific application. As an example, system 100 can operate at 20 MHz and accordingly, the wavelength of the acoustic wave propagating through the composite material 108 can be 70-150 microns. In this example scenario, insertion loss can be reduced and acoustic wave propagation efficiency can be improved by utilizing an anti-scratch material 112 having a thickness of 1 micron and a cover material 110 having a thickness of 1-2 millimeters. It is noted that the term “anti-scratch material” as used herein relates to a material that is resistant to scratches and/or scratch-proof and provides substantial protection against scratch marks.

Additionally, it is noted that the design of system 100 can include different material selections, topologies, etc., to achieve efficient acoustic wave propagation with a scratch resistant surface. Moreover, it is noted that the acoustic sensing element 102 and the composite material 108 can include most any components and circuitry elements of any suitable value in order to implement the embodiments of the subject innovation. Further, it can be appreciated that the components of system 100 can be implemented on one or more integrated circuit (IC) chips.

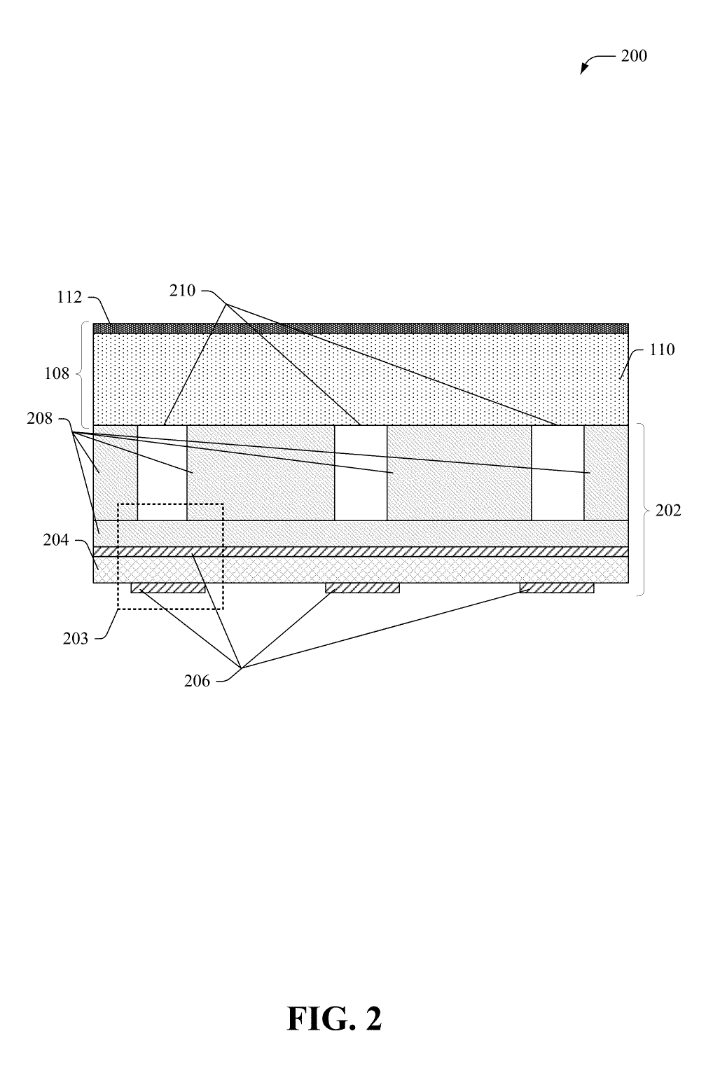

Referring now to FIG. 2, there illustrated is an example system 200 depicting another implementation of an acoustic sensor that includes a composite material deposited over an acoustic sensing element, according to an aspect of the specification. In one aspect, the system 200 can comprise an acoustic sensing element 202 for generating and/or sensing acoustic waves. As an example, the acoustic sensing element 202 can be the same as or substantially similar to acoustic sensing element 102 that is formed by a layer of piezoelectric material 104 with patterned electrodes 106, as more fully described with respect to system 100. In another example, the acoustic sensing element 202 can include a piezoelectric micromachined ultrasonic transducer (pMUT) structure 203 with patterned electrodes 206. The pMUT structure 203 can operate based on the flex-tensional motion of a thin membrane coupled with a thin piezoelectric film 204, such as, but not limited to, MN, PZT, etc., to facilitate acoustic sensing. The piezoelectric film can sense mechanical vibrations caused by an acoustic signal and produce an electrical charge at the frequency (e.g., ultrasonic frequency) of the vibrations that can be collected by electrodes 206. Additionally, the piezoelectric film can generate an acoustic wave based on an input current generated by an alternating current (AC) voltage applied across the electrodes 206. As an example, the electrodes 206 can be most any metal layers, such as, but not limited to, Al/Ti, Mo, etc. that are patterned to form shapes (e.g., circle, square, octagon, hexagon, etc.) and are defined in-plane with the membrane.

According to an aspect, the acoustic sensing element 202 can comprise of an array (e.g., two-dimensional, one-dimensional, etc.) of sensing elements having respective waveguides 210. The waveguides 210 can be formed by a combining waveguide material and an acoustic medium that comprises a material utilized for acoustic wave propagation. The waveguides 210 are covered with the composite material 108. It is noted that the composite material 108, the cover material 110, and the anti-scratch material 112 can include functionality, as more fully described with respect to system 100. In one aspect, the sensing elements can generate and/or sense acoustic waves. As described herein, an object in a path of the generated acoustic wave can create an interference (e.g., in time of flight, amplitude, frequency and/or phase) that can then be sensed by the sensing element and analyzed to determine an image, distance, density and/or motion of the object. Moreover, since the waveguides 210 guide the acoustic waves to/from each sensing element, each sensing element will sense only a portion of the object that is directly above the sensing element. Accordingly, system 200 provides a simplistic read-out configuration wherein each sensing element can read its own pixel of an object on (or near) the surface of the anti-scratch material 112. It is noted that although only three waveguides associated with three sensing elements are depicted in FIG. 2, the subject system is not so limited and that greater or fewer number of waveguides and corresponding sensing elements can be utilized. Moreover, the system 200 can be utilized in various applications, such as, but not limited to, wireless devices, industrial systems, automotive systems, robotics, telecommunications, security, medical devices, etc. In one aspect, system 200 can be part of a sensor array (e.g., two-dimensional array, one-dimensional array, etc.) comprising a plurality of acoustic sensors deposited on a wafer.

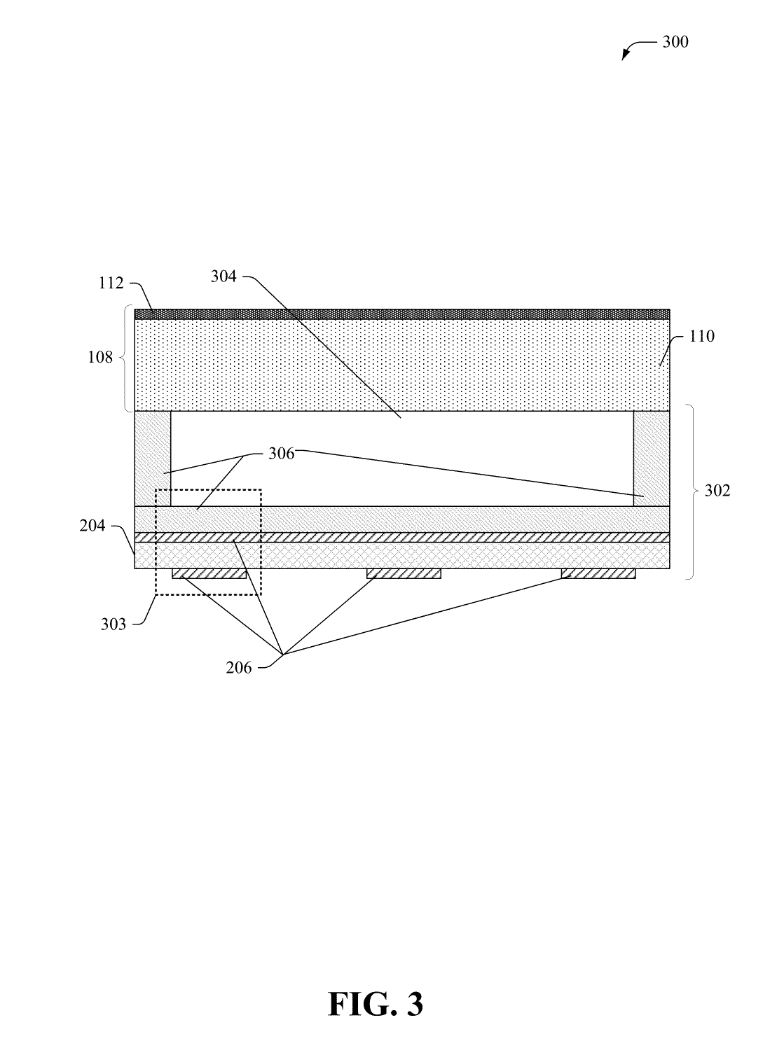

FIG. 3 illustrates an example system 300 depicting yet another implementation of an acoustic sensor that includes a composite material deposited over an acoustic sensing element, according to an aspect of the specification. In one aspect, the system 300 can comprise an acoustic sensing element 302 for generating and/or sensing acoustic waves. As an example, the acoustic sensing element 302 can be the same as or substantially similar to acoustic sensing element 102 comprising a layer of piezoelectric material 104 with patterned electrodes 106, a more fully described with respect to system 100. In another example, the acoustic sensing element 302 can include a pMUT structure 303 with patterned electrodes 206. Moreover, the pMUT structure 303 can be manufactured on a silicon-on-insulator (SOI) substrate and a piezoelectric material 204 (e.g., MN, PZT, etc.) and metal layers (e.g., Al/Ti, Mo, etc.) can be disposed on the substrate.

According to an embodiment, the acoustic sensing element 302 can comprise of an array (e.g., two-dimensional, one-dimensional, etc.) of sensing elements that are covered (e.g., completely and/or partially) by a large shared acoustic propagation space 304. As an example, the acoustic propagation space 304 comprising an acoustic medium surrounded by (e.g., completely and/or partially) a waveguide material 306. Typically, the acoustic medium can be most any a material that facilitates acoustic wave propagation. In one aspect, the acoustic propagation space 304 shared by/common to the sensing elements allows for beam forming and/or scanning of an object on (or near) the surface of the anti-scratch material 112. Complex processing and/or control can be performed to implement a time delay between different rows/columns of the array such that a desired beam of an acoustic wave is formed. Further, the time delay can be manipulated such that the beam scans through the defined area on (or near) surface of the anti-scratch material 112. Each sensing element can perform sensing (e.g., of the interfered acoustic wave) at the same time (or substantially the same time) to detect the signals associated with different portions/pixels of the object, which can then be analyzed to reconstruct an image of the object, for example, according to the different time delays associated with the signals.

The acoustic propagation space 304 is covered with the composite material 108. It is noted that the composite material 108, the cover material 110, the anti-scratch material 112, the pMUT structure 303, electrodes 206 can include functionality, as more fully described with respect to systems 100-200. Further it is noted that although only three sensing elements are depicted to share acoustic propagation space 304 in FIG. 3, the subject system is not so limited and greater or fewer number of sensing elements can be utilized. Moreover, the system 300 can be utilized in various applications, such as, but not limited to, wireless devices, industrial systems, automotive systems, robotics, telecommunications, security, medical devices, etc. In one aspect, system 300 can be part of a sensor array (e.g., two-dimensional array, one-dimensional array, etc.) comprising a plurality of acoustic sensors deposited on a wafer.

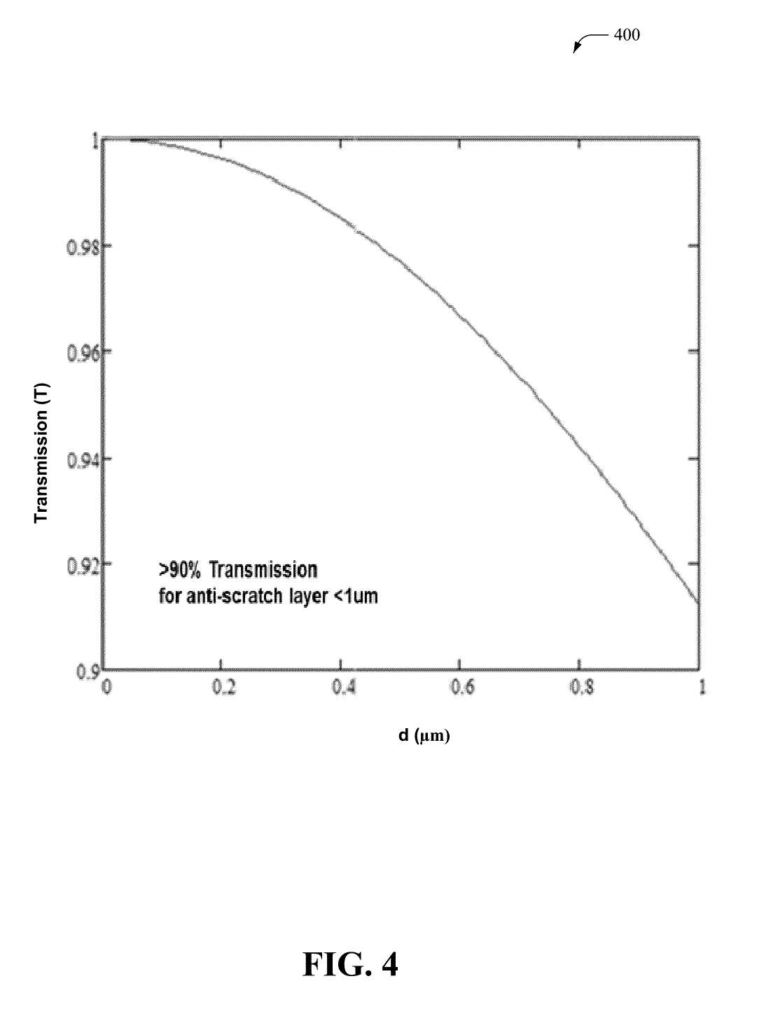

Referring now to FIG. 4, there illustrated is an example graph 400 that depicts simulation results for transmission efficiency of the acoustic sensor (e.g., of systems 100-300) that utilizes a composite material 108 deposited over an acoustic sensing element (e.g., 102, 202, and/or 302). Moreover, graph 400 depicts an impact of the thickness of an anti-scratch material 112 on the transmission efficiency associated with sensing an object placed over (or near) a surface of the anti-scratch material 112. As an example, when the object (e.g., a finger) is placed over (or near) the acoustic sensor a three layer structure is formed, wherein the top layer comprises the object, the bottom layer comprises the cover material 110 and the middle layer comprises the anti-scratch material 112. If the top layer (e.g., object) and the bottom layer (e.g., cover material 110) have the same or substantially similar acoustic impedance (e.g., 1.6×10⁶Rayl that is similar to the acoustic impedance of human skin), while the middle layer has a different (e.g., higher) acoustic impedance (e.g., 25×10⁶Rayl that is similar to the acoustic impedance of sapphire), the acoustic transmission though the sensor can be described by the below equations:

$$\begin{matrix}\vert T \vert = \frac{1}{{ξ}^{2} {sin}^{2} ( {k}_{o} d ) + 1} , & ( 1 ) \\ ξ = ( \frac{{z}_{0}}{{z}_{1}} - \frac{{z}_{1}}{{z}_{0}} ) / 2 , & ( 2 )\end{matrix}$$

Wherein, “T” is a transmission coefficient; “K₀” is a wave number in the cover material 110 (2πf/c); “d” is the thickness of anti-scratch material 112; “Z₀” is the acoustic impedance of the top and bottom layers (e.g., the object and the cover material 110); and “Z₁” is the acoustic impedance of middle layer (e.g., the anti-scratch material 112). As illustrated in graph 400, the transmission (T) decreases with an increase in the thickness (d) of the anti-scratch material 112. However, it is noted that transmission efficiency greater than 90% can still be maintained if the anti-scratch material 112 has a thickness of less than 1 μm.

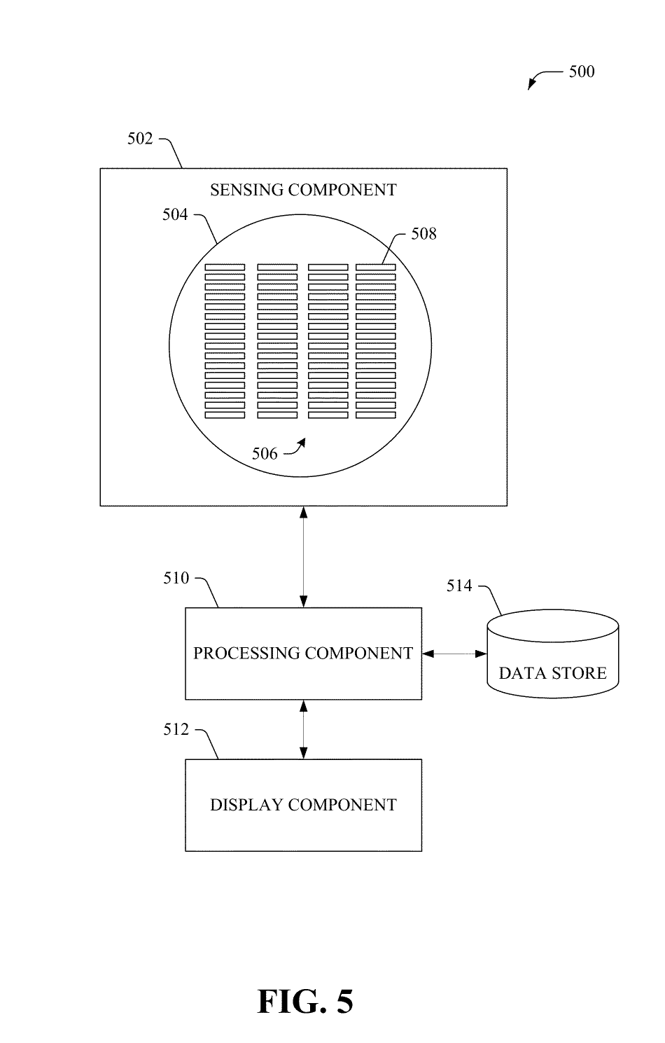

FIG. 5 illustrates an example system 500 utilized for analysis of acoustically sensed data in accordance with an aspect of the subject disclosure. System 500 can be utilized in various applications, such as, but not limited to, medical applications, security systems, biometric systems (e.g., fingerprint sensors and/or motion/gesture recognition sensors), mobile communication systems, industrial automation systems, consumer electronic devices, robotics, etc. In one aspect, system 500 can include a sensing component 502 that can facilitate acoustic sensing. Moreover, the sensing component 502 can include a silicon wafer 504 having a two-dimensional (or one-dimensional) array 506 of acoustic sensors 508, for example, systems 100, 200 and/or 300. As an example, the acoustic sensor 508 can comprise a piezoelectric substrate with patterned electrodes (e.g., as depicted in system 100), a waveguide on a pMUT or a piezoelectric substrate with patterned electrodes (e.g., as depicted in system 200), and/or an acoustic propagation space on a pMUT or a piezoelectric substrate with patterned electrodes (e.g., as depicted in system 300). In addition, the sensing elements of the acoustic sensor 508 can be covered with a composite material 108 including the cover material 110 and the anti-scratch material 112.

During a transmission mode, a set of acoustic sensors 508 of the two-dimensional array 506 can transmit an acoustic signal (e.g., a short ultrasonic pulse) and during a sensing mode, the set of the acoustic sensors 508 can detect an interference of the acoustic signal with an object in the path of the acoustic wave. The received interference signal (e.g., generated based on reflections, echoes, etc. of the acoustic signal from the object) can then be analyzed by a processing component 510. As an example, the processing component 510 can determine an image of the object, a distance of the object from the acoustic sensors 508, a density of the object, a motion of the object, etc. As an example, the processing component 510 can compare a phase and/or frequency of the interference signal with that of the acoustic signal to determine the image, distance, density, and/or motion of the object. Additionally or optionally, results generated by the processing component 510 can be further analyzed, presented to a user via a display component 512, and/or stored within a data store 514. As an example, the display component 512 can enable subscriber-device interaction via at least one of a touch-responsive screen or otherwise such as a liquid crystal display (LCD), a plasma panel, a monolithic thin-film based electrochromic display; a sound interface; or the like. Additionally or alternatively, the display component 512 can also include an audio component (e.g., speaker(s)) that facilitates communication of aural indicia, which can be employed in connection with messages that convey instructions to an end user or consumer.

In one example, for fingerprinting applications, the object can be a human finger and the processing component 510 can determine, based on a difference in interference of the acoustic signal with valleys and/or ridges of the skin on the finger, an image depicting epi-dermis and/or dermis layers of the finger. Further, the processing component 510 can compare the image with a set of known fingerprint images, for example, stored in a data store 514 to facilitate identification and/or authentication. Moreover, in one example, if a match (or substantial match) is found, the identity of user can be displayed via the display component 512. In another example, if a match (or substantial match) is found, a command/operation can be performed based on an authorization rights assigned to the identified user. In yet another example, the identified user can be granted access to a physical location and/or network/computer resources (e.g., documents, files, applications, etc.)

It is noted that the processing component 510, the display component 512, and/or the data store 514 can be locally and/or remotely coupled to the sensing component 502 via most any wired and/or wireless communication network. Further, it is noted that the processing component 510 and/or the display component 512 can include one or more processors configured to confer at least in part the functionality of system 500. To that end, the one or more processors can execute code instructions stored in memory, for example, volatile memory and/or nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data stores, databases) of the subject systems and methods is intended to comprise, without being limited to, these and any other suitable types of memory.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

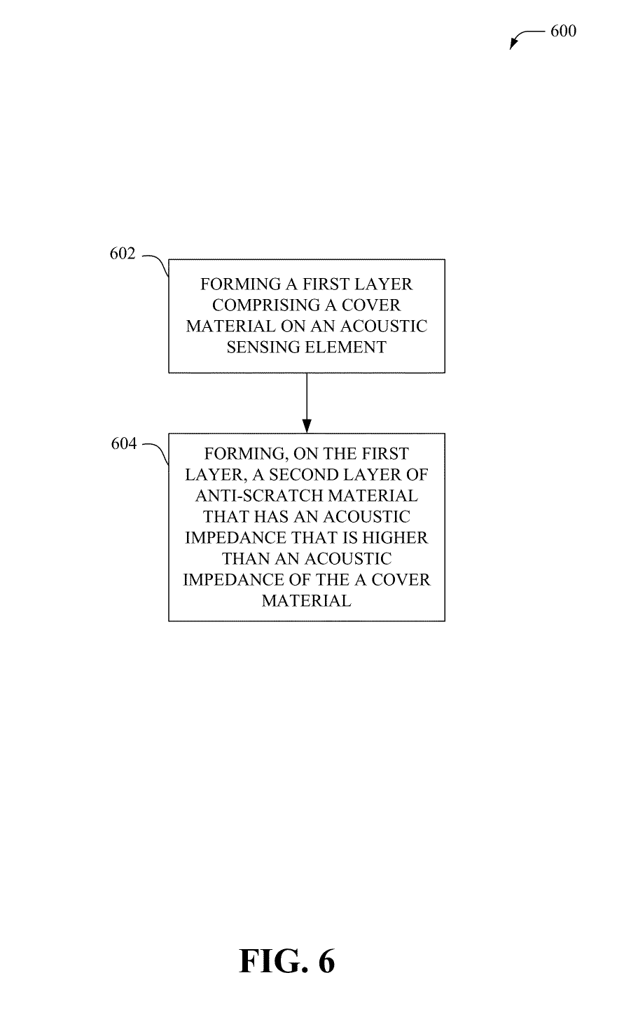

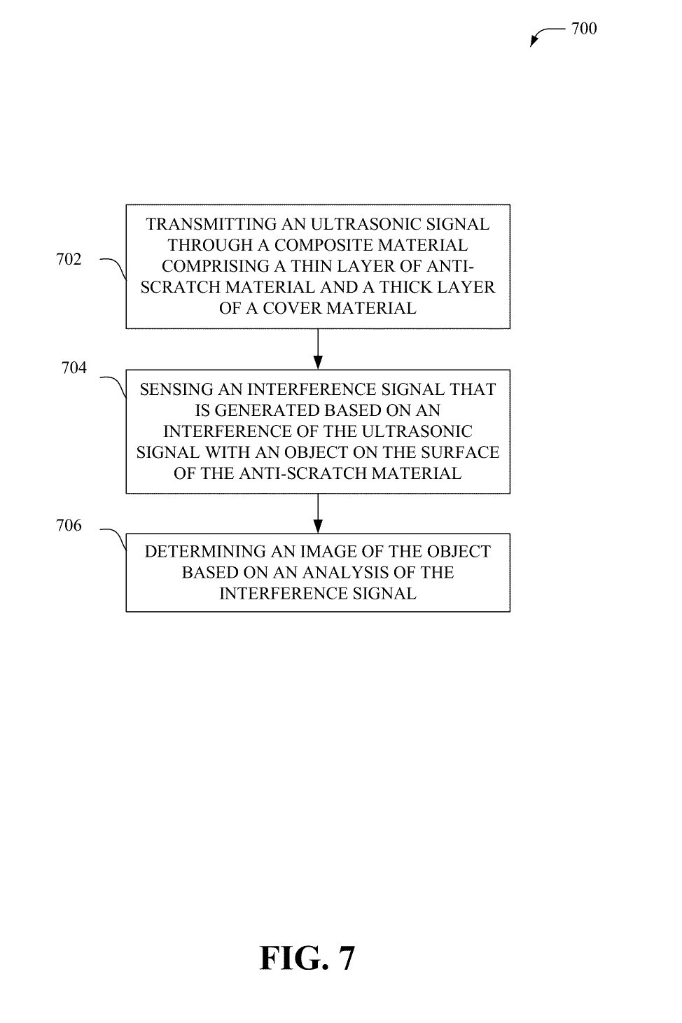

FIGS. 6-7 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or computer-readable storage/communications media.

FIG. 6 illustrates an example methodology 600 for forming an acoustic sensor that includes a composite material deposited over an acoustic sensing element in accordance with an aspect of the subject disclosure. Specifically, methodology 600 balances a trade-off between scratch resistance and attenuation loss in materials covering the acoustic sensing element. At 602, a first layer of a cover material can be formed on (deposited over) an acoustic sensing element. As an example, the cover material can include, but is not limited to, plastic, resin, Teflon, and/or rubber. In an aspect, the acoustic sensing element can include a piezoelectric material, such as, but not limited to, AlN, PZT, etc. to facilitate acoustic sensing. Further, the acoustic sensing element can include a metal layer (e.g., Al/Ti, Mo, etc.) that forms a set of patterned electrodes 106 utilized to supply and/or collect the electrical charge to/from the piezoelectric material. At 604, a second layer of an anti-scratch material, which has an acoustic impedance that is greater than the acoustic impedance of the cover material, can be formed on the first layer. As an example, the anti-scratch material can include, but is not limited to, sapphire, glass, AlN, TiN, SiC, diamond, and/or other material with Mohs hardness greater than 7 that is resistant to scratches/scuffs. Moreover, the combination of the first and second layers enables an acoustic wave to efficiently propagate through the sensor while providing protection from and/or preventing scratches. In one aspect, the thickness of the second layer is less than the thickness of the first layer and is typically less than the wave length of the acoustic wave to provide minimum interference/attenuation loss during propagation of the acoustic wave.

FIG. 7 illustrates an example methodology 700 for determining an image of an object based on acoustic sensing in accordance with an aspect of the subject disclosure. At 702, an ultrasonic signal (e.g., a pulse) can be transmitted through a composite material comprising a thin layer of anti-scratch material (e.g., sapphire, glass, AlN, TiN, SiC, diamond and/or other material with Mohs hardness greater than 7) and a thick layer of a cover material (e.g., plastic, resin, rubber, Teflon and/or other material with an acoustic impedance in the range of 0.8 to 4MRayl). In one aspect, the cover material is sandwiched between the anti-scratch material and an acoustic sensing element that generates the ultrasonic signal. As an example, the acoustic sensing element can comprise a piezoelectric substrate with patterned electrodes; a waveguide on a pMUT or a piezoelectric substrate with patterned electrodes; and/or am acoustic propagation space on a pMUT or a piezoelectric substrate with patterned electrodes. Moreover, one side of the cover material can be in contact with the acoustic sensing element and the other side of the cover material can be in contact with the anti-scratch material. The remaining side of the anti-scratch material can serve as a contact surface, for example, a surface on which an object (e.g., human finger) to be sensed is placed.

At 704, an interference signal that is generated based on an interference of the ultrasonic signal with an object on (or near) the surface of the anti-scratch material can be sensed. Moreover, the interference signal propagates back through the anti-scratch material and the cover material, and can be sensed by the acoustic sensing element. At 706, an image of the object can be determined based on an analysis of the interference signal (e.g., phase and/or frequency analysis). For example, when a finger is placed on the surface, a fingerprint can be reconstructed based on the acoustic impedance difference between valley and ridges on the finger.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and/or components have been described with respect to interaction between several components. It can be appreciated that such systems and/or components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, may be provided to communicatively couple to such sub-components in order to provide integrated functionality. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An acoustic sensor, comprising:
an acoustic sensing element; and
a cover material deposited between the acoustic sensing element and an anti-scratch material, wherein an acoustic impedance of the cover material is lower than an acoustic impedance of the anti-scratch material.

2. The acoustic sensor of claim 1, wherein a thickness of the anti-scratch material is less than a wavelength of a sensed acoustic wave.

3. The acoustic sensor of claim 1, wherein the acoustic impedance of the cover material matches an acoustic impedance of skin.

4. The acoustic sensor of claim 1, wherein the cover material comprises at least one of plastic, resin, Teflon, or rubber.

5. The acoustic sensor of claim 1, wherein the acoustic impedance of the cover material lies within a range of 0.8 MRayl to 4 MRayl.

6. The acoustic sensor of claim 1, wherein the anti-scratch material comprises at least one of sapphire, glass, Aluminum Nitride, Titanium Nitride, Silicon Carbide, or diamond.

7. The acoustic sensor of claim 1, wherein the anti-scratch material comprises a material having a hardness greater than seven on Mohs scale.

8. The acoustic sensor of claim 1, wherein the acoustic sensing element comprises a two-dimensional array of acoustic sensing elements.

9. The acoustic sensor of claim 8, wherein the acoustic sensing elements comprise a piezoelectric substrate with patterned electrodes.

10. The acoustic sensor of claim 8, wherein the acoustic sensing elements have respective waveguides that are employable to direct an acoustic wave between the cover material and a piezoelectric substrate.

11. The acoustic sensor of claim 10, wherein the respective waveguides comprise a waveguide material combined with an acoustic medium, wherein the acoustic medium comprises a material employable for propagation of the acoustic wave.

12. The acoustic sensor of claim 8, wherein the acoustic sensing elements are covered by a common acoustic propagation space.

13. The acoustic sensor of claim 12, wherein the common acoustic propagation space comprises a waveguide material combined with an acoustic medium, and wherein the acoustic medium comprises a material employable for acoustic wave propagation.

14. The acoustic sensor of claim 1, wherein the acoustic sensing element transmits an ultrasonic signal that is propagated through the cover material and the anti-scratch material.

15. The acoustic sensor of claim 14, wherein the acoustic sensing element receives an acoustic interference signal that is generated based on an interference of the ultrasonic signal with an object, wherein the acoustic interference signal is processed to determine an image of the object.

16. The acoustic sensor of claim 1, comprising a fingerprint sensor.

17. A method, comprising:
forming a first layer of a cover material on an acoustic sensing element; and
forming a second layer of a scratch-resistant material on the cover material, wherein an acoustic impedance of the cover material is lower than an acoustic impedance of the scratch-resistant material.

18. The method of claim 17, wherein the forming the second layer comprises forming the second layer having a thickness that is less than a wavelength of a sensed acoustic wave.

19. The method of claim 17, wherein the forming the first layer comprises forming the first layer of at least one of plastic, resin, rubber, Teflon, or a material having an acoustic impedance between 0.8 MRayl to 4 MRayl.

20. The method of claim 17, wherein the forming the second layer comprises forming the second layer of at least one of sapphire, glass, aluminum nitride, Silicon carbide, Titanium nitride, diamond, or a scratch-resistant material having a hardness of more than seven on Mohs scale.

21. The method of claim 17, wherein the forming the first layer comprises forming the first layer over a two-dimensional array of acoustic sensing elements.

22. The method of claim 21, further comprising:
forming a set of respective waveguides for the acoustic sensing elements that are employable to direct an acoustic wave between the cover material and a piezoelectric substrate.

23. The method of claim 21, further comprising:
forming a shared acoustic propagation space over the acoustic sensing elements.

24. The method of claim 17, wherein the forming the first layer comprises forming the first layer over a piezoelectric substrate with patterned electrodes.

25. A method for acoustic sensing, comprising:
transmitting, by an acoustic sensing element, an ultrasonic signal through a cover material and an anti-scratch material, wherein the cover material is deposited between the acoustic sensing element and the anti-scratch material and wherein an acoustic impedance of the cover material is lower than an acoustic impedance of the anti-scratch material; and
sensing, by the acoustic sensing element, an interference signal that is generated based on an interference of the ultrasonic signal with an object and that propagates through the anti-scratch material and the cover material.
